(19) United States
(12) Patent Application Publication
(10) Pub. No.: US 2011/0128732 A1
(43) Pub. Date: Jun. 2, 2011

(54) Rotational ribbon flame effect electric fire

(76) Inventor: Michael Mantooth, Baldwinsville, NY (US)

(21) Appl. No.: 12/626,885

(22) Filed: Nov. 28, 2009

(51) Int. Cl. F21V 7/00

(52) U.S. Cl. 362/235; 362/341

(57) ABSTRACT

A simulated electric fire is comprised of a frame chassis 7 with an illumination source 1, utilizing either lamps or LEDs, a horizontal axis motor 5 affixed to the frame chassis 7, with the motor shaft securely affixed to a cross bar shaft 8. Variations in the cross bar shaft design can be used to create different flame effect patterns. The opposite end of the cross bar shaft 8 is secured in a bearing housing 11, which is affixed to the frame chassis 7 on the opposing side but concentric with the horizontal axis motor 5. Swivel joints, loose fitting rings, or similar devices 9, which are attached to the reflective ribbon sheet or multiple reflective ribbon strips 2, are connected to the cross bar shaft 8. The light source 1 illuminates the reflective ribbon sheet or multiple reflective ribbon strips 2 and the horizontal axis motor 5 rotates the motor shaft driving the cross bar shaft 8 in a circular, vertical plane motion. The horizontal axis motor 5 is located such that its direction of rotation imparts an upward movement of the reflective ribbon sheet or multiple reflective ribbon strips 2 when the sheet or strips are closer to the glass or plastic panel 4, or in the fore position. This action provides the flame tip movement. The downward movement of the reflective ribbon sheet or multiple reflective ribbon strips as they are rotating to the aft position provides the flame depth perception. The colors of the glass or plastic panel 4 and of the light source 1 may be adjusted to produce the desired flame colors.

### BACKGROUND

This invention relates to the simulation of a realistic flame using an illumination source, reflective ribbon cloth, and a motor driven rotational movement in a vertical plane. This invention provides a realistic 3D flame effect by applying methods not previously used. UK patent # GB2385413 is similar in concept, but an improvement in the simulation of the flame movement of a fire is achieved with this invention.

### STATEMENT OF INVENTION

The present invention proposes the application of a horizontally fixed axis motor to produce a vertical plane rotation of a cross bar shaft, which is connected to a reflective ribbon sheet or multiple reflective ribbon strips using swivel joints or loose fitting rings. The circular, vertical plane rotation of the cross bar shaft provides not only up and down movement, but also fore and aft movement, of the reflective ribbon sheet or the multiple reflective ribbon strips. The reflective ribbon sheet or multiple reflective ribbon strips are placed behind a glass or plastic panel of various alternate colors, dependent on the desired flame color or colors, and illuminated by either single or multiple color LEDs or by various alternate color lamps.

### ADVANTAGES

The up and down movement, along with the fore and aft movement, of the reflective ribbon sheet or the multiple reflective ribbon strips create vertical rolling flame action while the fore and aft movement creates an improved flame depth perception, both at the base and at the tip of the flame. Also, variations of the cross bar shaft design configurations and variations in the methods of attachment of the reflective ribbon sheet or multiple reflective ribbon strips to the swivel joints or loose fitting rings will create various flame patterns.

### DESCRIPTION

This invention relates to a simulated flame effect for electric fires.

The idea of this invention is to provide vertical flame movement and flame depth perception to an electric fire mounted in a thin chassis electric fire body while using a motor driven reflective ribbon cloth or multiple reflective ribbon strips and to allow for variations in the flame patterns produced.

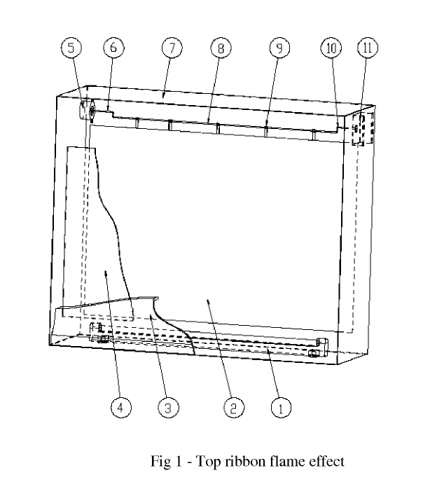

The embodiment of the invention will now be described. Refer to FIG. 1 for details.

The electric fire is comprised of a frame chassis 7, an illumination source 1, a horizontal axis motor 5 affixed to the frame chassis 7, with the motor shaft securely affixed to a cross bar shaft 8, which can be of variable designs to create different 3D flame effect patterns. The opposite end of the cross bar shaft 8 is secured in a bearing housing 11, which is affixed to the frame chassis 7 on the opposite side but concentric with the horizontal axis motor 5. Swivel joints, loose fitting rings, or similar devices 9, which are attached to the reflective ribbon sheet or multiple reflective ribbon strips 2, are connected to the cross bar shaft 8. The reflective ribbon sheet or multiple reflective ribbon strips are located behind a glass or plastic panel 4, which is affixed to the frame chassis 7 behind the artificial fuel bed 3.

When the motor and light source are powered on, the light source 1 illuminates the reflective ribbon sheet or multiple reflective ribbon strips 2 from the front underside and the horizontal axis motor 5 rotates the cross bar shaft 8 in a circular, vertical plane motion, thus moving the reflective ribbon sheet or multiple reflective ribbon strips 2 in the following pattern: up-fore, up-aft, down-aft, down-fore. The inclusion of these four directions of movement of the reflective ribbon sheet or multiple reflective ribbon strips 2 provide the desired rolling flame and 3D flame effect patterns. Concentric offsets of the connection points of the reflective ribbon sheet or multiple reflective ribbon strips, as achieved by variations in the design configuration of the cross bar shaft, will result in variations in the 3D flame patterns developed.

1. A simulated flame effect within a chassis or main fire body using a motor driven unit to provide four direction movement of a reflective ribbon sheet or multiple reflective ribbon strips to produce a 3D flame-like pattern.

2. A motor mounted within a chassis or a main fire body as in claim 1, which results in a 3D flame-like pattern movement of a reflective ribbon sheet or multiple reflective ribbon strips which move in upward extending flame like ways when the cross bar shaft rotates in a circular vertical plane.

3. A motor, reflective ribbon sheet or multiple ribbon strips, and cross bar shaft mounted within a chassis or electric fire body as in claim 2 which moves in flame-like ways and produces realistic simulated 3D flames when a glass or plastic panel and LEDs or lamps are correctly fitted and the LEDs or lamps are illuminated.
